(19) United States
(12) Patent Application Publication
(10) Pub. No.: US 2018/0174373 A1
(43) Pub. Date: Jun. 21, 2018

(54) SYNTHETIC FAULT CODES

(71) Applicant: International Engine Intellectual Property Company , LLC, Lisle, IL (US)

(72) Inventors: Richard Hansen, Lockport, IL (US); Christopher Lappa, Lockport, IL (US); Dominic Vito Venice, Naperville, IL (US)

(73) Assignee: International Engine Intellectual Property Company , LLC, Lisle, IL (US)

(21) Appl. No.: 15/591,772

(22) Filed: May 10, 2017

Related U.S. Application Data
(60) Provisional application No. 62/336,247, filed on May 13, 2016.

(51) Int. Cl. G07C 5/00; B60R 16/023; G07C 5/08

(52) U.S. Cl. CPC G07C 5/006; G07C 5/008; G07C 5/0816; B60R 16/0232

(57) ABSTRACT

A synthetics rules creation processor or portal recognizes correlations between vehicle data and conditions, corporate knowledge and memory, company proprietary information, vehicle location, customer reported symptoms, and vehicle electronic control module fault codes. The synthetics rule creation processor or portal generates synthetic rules based on the correlations. A synthetic fault processor or synthetics engine compares current vehicle data and conditions, vehicle location, customer reported symptoms, and fault codes against the synthetic rules. The fault processor or synthetics engine generates synthetic fault codes based upon matching comparisons. The at least one synthetic fault code, along with an action plan, thereafter becomes part of a vehicle health report.

### CROSS REFERENCE TO RELATED APPLICATIONS

This is a non-provisional application based on U.S. provisional patent application Ser. No. 62/336,247, entitled “SYNTHETIC FAULT CODE”, filed May 13, 2016, which is incorporated herein by reference.

### BACKGROUND

### Field of Invention

Embodiments described herein generally relate to a system and method for reducing the amount of time a vehicle is in the shop for service or maintenance, while providing correlated information regarding vehicle conditions to an organization such as an Original Equipment Manufacturer (OEM) and/or a dealer or service network.

### Related Art

A vehicle, such as a truck, a bus, and the like, is often provided with at least one, and often several, electronic modules that govern the operation of various components or sub-systems of the vehicle. Such modules which may be used in vehicles include an Engine Control Module, a Transmission Control Module, a Body Control Module, and an Antilock Brake System Control Module as non-limiting examples. In addition to governing the operation of their respective components or sub-systems, these control modules may also generate fault codes when operation of the respective component or sub-system does not correspond with the commands given by the control module, as determined for example by way of sensors and other feedback mechanisms. The generation of a fault code by a control module of an individual vehicle component or sub-system thereby gives indication that maintenance is required for that individual vehicle component or sub-system.

Each of the more than one control modules contains only logic related to its respective component or sub-system, which may or may not be updated after the vehicle is manufactured. This may lead to diagnosing fault code one at a time, in isolation from other fault codes, especially other fault codes generated by other control modules. However, component failures within the complex systems of modern vehicles are often interrelated and may have multiple causes or potential causes, and may in fact result in fault codes being generated by more than one control modules and/or multiple, conflicting, or overlapping repairs, as the failure or failures affect more than one vehicle component or sub-system. This requires that a technician proceed along several diagnostic paths related to each fault code, in order to determine, if possible, the root cause of the problem.

In addition to the multiple fault codes generated by more than one control module, drivers often report vehicle symptoms to a service manager upon write-up of the repair order, which symptoms are then reported to the technician. The technician must then integrate consideration of the symptoms into his or her diagnosis of the problem, either through accumulated experience or by searching diagnostic manuals for repair information based on the symptoms. Naturally, accumulated experience varies widely from technician to technician. As a result, relationships between fault codes and customer reported symptoms may not be consistently identified, so that procedures may be duplicated and/or repairs may be ineffective.

OEM's often ship repair parts to Parts Distribution Centers (PDC's) and dealerships based on dealership size and quantity of vehicle repairs conducted by such dealerships. In order to facilitate timely repairs and to minimize unused repair parts and vehicles awaiting the shipment of correct repair parts, OEM's attempt to provide the correct quantity of repair parts to the PDC's and dealerships in advance of the immediate need for the repair parts. Some of these repairs are managed repairs, for example vehicles sharing a common range of build dates based on limited knowledge of their operating environment, configuration, and characteristics. Often, however, repairs are needed spontaneously. In either case, limited knowledge of vehicle conditions and environment, and fault code and customer reported symptom correlations hampers efforts to efficiently provide for diagnosis and repairs.

OEM's additionally provide electronic service tools, or partner with service tool providers, in order to communicate with the controllers and systems of vehicles for the purpose of diagnosing, and when applicable, performing vehicle repairs and maintenance. These electronic service tools must from time to time be updated and/or calibrated, often by way of internet connectivity. Where such internet connectivity is absent, or where dealers or service technicians fail to allow such updating and/or calibration to occur, electronic service tools may be used with out-of-date programming or information, or in an un-calibrated condition.

Accordingly, there is an unmet need for a system and method for correlating information regarding vehicle conditions, fault codes of various controllers, environmental conditions, GPS reported location, and/or customer reported symptoms, and providing for an organization such as an Original Equipment Manufacturer (OEM) and/or its dealer or service network to make use of such correlated information in diagnosing and performing vehicle repairs, in shipping and stocking repair parts, and in updating and/or calibrating electronic service tools.

### SUMMARY

Embodiments described herein relate to a system and method for correlating information regarding vehicle conditions, fault codes of various vehicle subsystem controllers, environmental conditions, GPS reported location, and/or customer reported symptoms, by way of Synthetic Fault Codes, and for providing at least one Synthetic Fault Code Action Plan. The system and method may be applied to vehicles of a single manufacturer or to vehicles of multiple manufacturers, and may be provided to dealers or technicians by way of subscription to the system. Logic circuits or programming within at least one synthetic fault processor or synthetics engine evaluate current vehicle data and conditions, fault codes, and/or customer reported symptoms against synthetics rules generated by at least one synthetics rules creation processor or portal. The at least one synthetic fault processor or synthetics engine does this in order to generate the Synthetic Fault Codes and/or the at least one Synthetic Fault Code Action Plan. The vehicle data and conditions may include in addition to fault codes, the date, mileage, engine hours operated, number of shifts, brake applications, and etcetera, location, routes travelled, where, when, and how often the fault(s) occurred, as non-limiting examples.

The synthetic fault codes including the least one Synthetic Fault Code Action Plan generated by the at least one synthetic fault processor or synthetics engine are published as part of a synthetics package, thereafter becoming part of a vehicle health report. The at least one Synthetic Fault Code Action Plan functions to communicate specific repair or maintenance information to a dealer or fleet technician specific to the combination of vehicle data, conditions, fault codes, corporate knowledge, memory, company proprietary information, and/or customer reported symptoms that are identified. If applicable, the at least one synthetic fault processor or synthetics engine may automatically “push” the repair or reprogramming as set forth in the at least one Synthetic Fault Code Action Plan.

The vehicle data and conditions may be received by the at least one synthetic fault processor or synthetics engine from previous health reports as part of a recursive process wherein fault codes, pings, and other information are received from the vehicle Closed Area Network (CAN) by way of a service portal or electronic service tool, or even telematically. Customer reported symptoms may be received by the at least one synthetic fault processor or synthetics engine by way of an intake assessment or intake interview, wherein each customer reported symptom is assigned a number or even its own fault code. The customer reported symptoms may be entered using the service portal or electronic service tool, or may be entered telematically by the customer. These vehicle conditions, fault codes of various controllers, environmental conditions, GPS reported location, and/or customer reported symptoms may be temporarily or permanently stored by the service portal, electronic service tool, or telematics system for future reference.

The at least one synthetics rules creation processor or portal functions to recognize previously unrecognized correlations between previous vehicle conditions, previous fault codes of various controllers, previous environmental conditions, previous GPS reported location, and/or previous customer reported symptoms using inferences derived at least in part from the aforementioned corporate knowledge and/or memory, and/or company proprietary information. The at least one synthetics rules creation processor or portal may function to recognize previously unrecognized correlations using at least one correlation recognizing algorithm. The corporate knowledge and/or memory may include technician case files, analytic models, previous vehicle data and conditions, repair history, service information, vehicle production information, vehicle configuration, vehicle parameter settings, vehicle calibration and software versions, business operational knowledge, financial models, customer information, weather information, location information, elevation, and/or dealer information, as non-limiting examples. Past and present location information and elevation may be acquired using the telematics system and/or GPS. Company proprietary information may include analytic models, engineering knowledge, historical warranty data, service engineering data, business operational knowledge, financial models, marketing information, and fleet location and elevation information, as non-limiting examples.

The at least one synthetics rules creation processor or portal then functions to create the synthetics rules utilized by the at least one synthetic fault processor or synthetics engine in triggering a Synthetic Fault Code. The synthetics rules may utilize at least one algorithm largely based on Boolean statements such as, “Where characteristic A is present, and where characteristic B is present, . . . and where characteristic N is present, then trigger Synthetic Fault Code Q,” as a non-limiting example. The synthetics rules may further be arranged to prioritize certain combinations of characteristics over others, based on severity or prevalence, as non-limiting examples. The synthetics rules may be based on threshold values, such as minimum oil pressure.

The synthetics rules may pass through a filter between the at least one synthetics rules creation processor or portal before being used by the at least one synthetic fault processor or synthetics engine, which filter may identify and/or remove conflicting, redundant, or otherwise flawed synthetics rules. Alternately, the at least one synthetics fault processor may incorporate such a filter. Each specific synthetic rule, although created for use in triggering a given Synthetic Fault Code, may be used for multiple related Synthetic Fault Codes. The synthetics rules, Synthetic Fault Codes, and previous vehicle health reports may be stored in the corporate knowledge and/or memory database or facility, or in a separate diagnostic database or system, together with or separate from the usual individual fault codes of various controllers, for use by the at least one synthetic fault processor or synthetics engine.

Thereafter, the at least one synthetic fault processor or synthetics engine will utilize the synthetics rules to determine whether to trigger a given Synthetic Fault Code each time a health report is to be created. In this way, a single or reduced number of Synthetic Fault Codes take the place of multiple individual fault codes from various vehicle electronic control modules. Similarly, a single or reduced number of Synthetic Fault Code Action Plans take the place of multiple individual fault code action plans based on those multiple individual fault codes. The at least one synthetics rules creation processor or portal may function entirely autonomously by way of at least one correlation recognizing algorithm, or may require validation, oversight, or direct guidance, such as by a technician, programmer, or engineer pre-identifying vehicle conditions and/or creating Synthetic Fault Code Action Plans, using an administrative tool. Oversight or guidance may involve associating the Synthetic Fault Codes with a fleet, Dun & Bradstreet number, series of VIN numbers, or account or sub-account, as non-limiting examples. The at least one synthetics rules creation processor or portal may even update or revise the questions appearing on the intake assessment, again autonomously, or requiring validation, oversight, or direct guidance. The Synthetic Fault Code or codes, once triggered, along with the Synthetic Fault Code Action Plan or plans they contain, in addition to becoming part of a health report, may also be visible using the service portal or electronic service tool. The vehicle health reports and/or fault code action plans may contain links to pertinent part numbers, recommendations of manufacturers, links to related preventative maintenance programs, and/or recommended fluid and filter change intervals. Further, the Synthetic Fault Code Action Plan may direct the technician to ask further questions of the customer, thereby refining the action to be taken.

This allows for rapid identification of problem root causes that often affect multiple vehicle sub-systems and trigger multiple fault codes from various vehicle subsystem controllers, and allows for the generation of a single or minimum number of Synthetic Fault Code Action Plans, thereby saving diagnostic time, eliminating redundant and unnecessary repairs, and minimizing vehicle downtime. Furthermore, recognizing correlations between current vehicle conditions, current fault codes of various controllers, current environmental conditions, current GPS reported location, and/or current customer reported symptoms using inferences derived from corporate knowledge and/or memory, and/or company proprietary information, including previously identified correlations, may identify issues that would previously have gone unnoticed when individual fault codes were considered in isolation. An example of such a previously unrecognized correlation of fault codes from individual vehicle subsystem controllers, and from customer reported symptoms, might include overheating engine oil combined with low tire pressure, further combined with customer reported rumbling noises, thereby indicating a failing compressor. The recurrence of particular Synthetic Fault Codes may indicate trends in groups of vehicles sharing common characteristics and operating environments, which may also be evaluated by the at least one synthetic fault processor or synthetics engine.

An accelerator tool, so named not for any relation to the vehicle accelerator pedal, but for its effect on increasing the rapidity of convergence of the recursive process on addressing problem root causes, receives field inputs such as fault codes, pings, and other information from the various vehicle subsystem controllers by way of the vehicle Closed Area Network (CAN), and/or receives customer reported symptoms, for example telematically. These items of information and/or customer reported symptoms may be identical to, similar to, or distinct from the information and/or symptoms provided to the at least one synthetic fault processor or synthetics engine by way of previous health reports as part of the aforementioned recursive process. Furthermore, the field inputs may include data and information from not only one, but a fleet, or even the entire population of a given vehicle type. The accelerator tool, which may for example be a handheld data entry tool, or an accelerator portal, additionally allows entry of human observations to accompany the fault codes and/or customer reported symptoms. These human observations may themselves be assigned fault codes, similar to the customer reported symptoms. These combined human observations and fault codes and/or customer reported symptoms then become part of the corporate knowledge and/or memory, and/or part of the health report.

Regular maintenance or verification of the synthetics rules, Synthetic Fault Codes, Synthetic Fault Code Action Plans, and/or corporate knowledge or memory database or facility may be required. This may take place at the knowledge or memory database level, and/or together with the human observations by way of the accelerator tool. In at least one embodiment, the Synthetic Fault Code Action Plans are created using the accelerator tool, and become available to the at least one synthetic fault processor or synthetics engine by way of the corporate knowledge and/or memory. Alternately, maintenance of the synthetics rules, Synthetic Fault Codes, Synthetic Fault Code Action Plans, and/or corporate knowledge or memory database or facility may take place using the administrative tool used by the technician, programmer, or engineer to validate, oversee, or intervene with the at least one synthetics rules creation processor or portal, as mentioned previously.

For example, the synthetics rules may be edited following introduction of a Synthetic Fault Code. Alternately, new synthetic rules may be substituted for outdated synthetics rules, for example when a new vehicle subsystem controller fault code is introduced. Similarly, the Synthetic Fault Codes may also be edited or replaced. New synthetic rules, Synthetic Fault Codes, and/or Synthetic Fault Code Action Plans may be introduced as a result of newly or externally recognized correlations, Synthetic Fault Code capabilities, or vehicle conditions. Further, each Synthetic Fault Code may be removed or disabled from the at least one synthetic fault processor or synthetics engine after its introduction, for example due to error, obsolescence, or inapplicability.

For a more specific example, an engineer may recognize that vehicle location and routes travelled may have an influence on breakdowns being experienced by certain vehicles. The engineer may then use the administrative tool to introduce a Global Positioning System component for evaluation by the synthetics rules creation processor or portal, along with certain thresholds of significance. The synthetic rules creation processor or portal may then recognize a correlation between the GPS component and other fault codes, conditions, or customer reported symptoms, and create at least one new synthetic rule for use by the at least one synthetic fault processor or synthetics engine in generating the Synthetic Fault Code or codes.

The synthetics rules creation processor or portal may recognize a correlation between fault codes, conditions, or customer reported symptoms and out of date service tool software. In this situation, the synthetics rules creation processor or portal may provide a Synthetic Fault Code and Synthetic Fault Code Action Plan to the at least one synthetic fault processor or synthetics engine requiring that the service tool software be updated before proceeding further, or may provide for the technician to accept the update with qualifications imposed in the Vehicle Health Report or Synthetic Fault Code Action Plan for failure to do so. The synthetics rules creation processor or portal may be utilized in conducting recalls and repair campaigns. In this situation, the synthetics rules creation processor or portal may provide a Synthetic Fault Code and Synthetic Fault Code Action Plan to the at least one synthetic fault processor or synthetics engine requiring that recall and campaign repairs be conducted before proceeding further, and communicating the required steps and procedures to the dealer technician. This allows for more targeted recalls and campaigns using the correlation recognition capabilities of the synthetics rules creation processor or portal. For example, repairs may be targeted at vehicles of a certain series of VIN of a certain mileage or operating hours, only operating within a certain geo-fenced area under certain conditions, having certain attributes, and/or exhibiting certain characteristics. This further enables targeted stocking of repair parts based on these correlated patterns.

According to one embodiment of the system for correlating vehicle related information, at least one synthetics rules creation processor or portal is configured to recognize at least one correlation between one previous vehicle datum, previous vehicle condition, previous corporate knowledge, previous corporate memory, previous company proprietary information, previous GPS reported location, previous customer reported symptom, or previous fault code generated by at least one vehicle electronic control module, and another previous vehicle datum, previous vehicle condition, previous corporate knowledge, previous corporate memory, previous company proprietary information, previous GPS reported location, previous customer reported symptom, or previous fault code generated by at least one vehicle electronic control module. The at least one synthetics rule creation processor or portal is further configured to generate at least one synthetic rule based on the at least one correlation. At least one synthetic fault processor or synthetics engine is configured to compare a current vehicle datum, a current vehicle condition, a current GPS reported location, a current customer reported symptom, and/or a current fault code generated by at least one vehicle electronic control module against the at least one synthetic rule. The at least one fault processor or synthetics engine is further configured to generate at least one synthetic fault code based upon a matching comparison. The at least one synthetic fault code thereafter becomes part of a vehicle health report.

According to one embodiment of the method for correlating vehicle related information, several steps are taken. The first step is recognizing with at least one synthetics rules creation processor or portal at least one correlation between one previous vehicle datum, previous vehicle condition, previous corporate knowledge, previous corporate memory, previous company proprietary information, previous GPS reported location, previous customer reported symptom, or previous fault code generated by at least one vehicle electronic control module, and another previous vehicle datum, previous vehicle condition, previous corporate knowledge, previous corporate memory, previous company proprietary information, previous GPS reported location, previous customer reported symptom, or previous fault code generated by at least one vehicle electronic control module. The second step is generating with the at least one synthetics rules creation processor or portal at least one synthetic rule based on the at least one correlation. The third step is comparing a current vehicle datum, a current vehicle condition, a current GPS reported location, a current customer reported symptom, and/or a current fault code generated by at least one vehicle electronic control module against the at least one synthetic rule using at least one synthetic fault processor or synthetics engine. The fourth step is generating at least one synthetic fault code based upon a matching comparison using the at least one fault processor or synthetics engine. The fifth step is making the least one synthetic fault code part of a vehicle health report.

Embodiments of the system and method system and method for correlating information regarding vehicle conditions, fault codes of various controllers, environmental conditions, GPS reported location, and/or customer reported symptoms using Synthetic Fault Codes can reduce complex knowledge of fault interrelationships, which may previously existed only in the minds of experienced technicians, to repeatable and targeted Synthetic Fault Code Action Plans having simplified diagnostic paths. Further, embodiments of the method and system can bring this information to the field quickly and efficiently, while leveraging corporate knowledge and company proprietary information by correlating it to the interrelated faults. Embodiments of the method and system place at the dealer technician's disposal data and inferences obtained from entire populations of vehicles and developing fault code trends therein, and minimizes the need to search through diagnostic manuals and manually shared information regarding vehicle symptoms. Further, embodiments of the method and system improve the body of corporate knowledge through recursive inputs from the accelerator tool. Embodiments of the method and system minimize redundant, overlapping, and unnecessary diagnostics and repairs, and maximize vehicle uptime.

Embodiments of the method and system can be expanded to include in the Vehicle Health Reports and/or the Synthetic Fault Code Action Plans additional information such as technician tips, collaborative communications between technicians, and/or wiki-type technician or public contributions. Embodiments of the method and system can further be expanded to include in the Vehicle Health Reports and/or the Synthetic Fault Code Action Plans marketing, advertising, sales, instructional video, diagrams, and/or guidance information.

### DESCRIPTION OF THE DRAWINGS

The above-mentioned and other features of the Synthetic Fault Codes, and the manner of their working, will become more apparent and the Synthetic Fault Codes will be better understood by reference to the following description of embodiments of the Synthetic Fault Codes taken in conjunction with the accompanying drawings, wherein:

FIG. 1 is a graphical representation of a Vehicle Health Report not utilizing Synthetic Fault Codes as described herein;

FIG. 2 is a graphical representation of an embodiment of a Vehicle Health Report having an embodiment of a Synthetic Fault Code with an internet link to a Synthetic Fault Code Action Plan, as described herein;

FIG. 3 is a graphical representation of a portion of an embodiment of a Vehicle Health Report having an embodiment of a Synthetic Fault Code with an internet link to a Synthetic Fault Code Action Plan, based on multiple J1939 data link communication fault codes, as described herein;

FIG. 4 is a graphical representation of a portion of an embodiment of a Vehicle Health Report having an embodiment of a Synthetic Fault Code with an internet link to a Synthetic Fault Code Action Plan, based on multiple Exhaust Gas Recirculation fault codes, as described herein;

FIG. 5 is a graphical representation of a portion of an embodiment of a Vehicle Health Report having an embodiment of a Synthetic Fault Code with an internet link to a Synthetic Fault Code Action Plan, based in part on customer reported symptoms, as described herein;

FIG. 6 is a graphical representation of a portion of an embodiment of a Vehicle Health Report having an embodiment of a Synthetic Fault Code with an internet link to a Synthetic Fault Code Action Plan, based in part on an Antilock Braking System fault code and in part on the need to update a service tool software, as described herein;

FIG. 7 is a graphical representation of a portion of an embodiment of a Vehicle Health Report having an embodiment of a Synthetic Fault Code with an internet link to a Synthetic Fault Code Action Plan, based on one or more Transmission fault codes, as described herein;

FIG. 8 is a graphical representation of a configuration of an embodiment of a Synthetic Fault Code administrative tool having a Synthetic Fault Code based on multiple conditions and fault codes, as described herein;

FIG. 9 is a graphical representation of an embodiment of a Synthetic Fault Code Action Plan based on a Synthetic Fault Code, based on multiple Exhaust Gas Recirculation fault codes and at least one customer reported symptom, as described herein;

FIG. 10 is a graphical representation of an embodiment of a Synthetic Fault Code Action Plan based on a Synthetic Fault Code, based in part on the need to update a service tool software, as described herein; and

FIG. 11 is a graphical representation of an embodiment of a system and method for correlating information regarding vehicle conditions, fault codes of various controllers, environmental conditions, GPS reported location, and/or customer reported symptoms using Synthetic Fault Codes.

Corresponding reference numbers indicate corresponding parts throughout the several views. The exemplification(s) set out herein illustrate embodiments of the Synthetic Fault Codes and such exemplification is not to be construed as limiting the scope of the claims in any manner.

### DETAILED DESCRIPTION

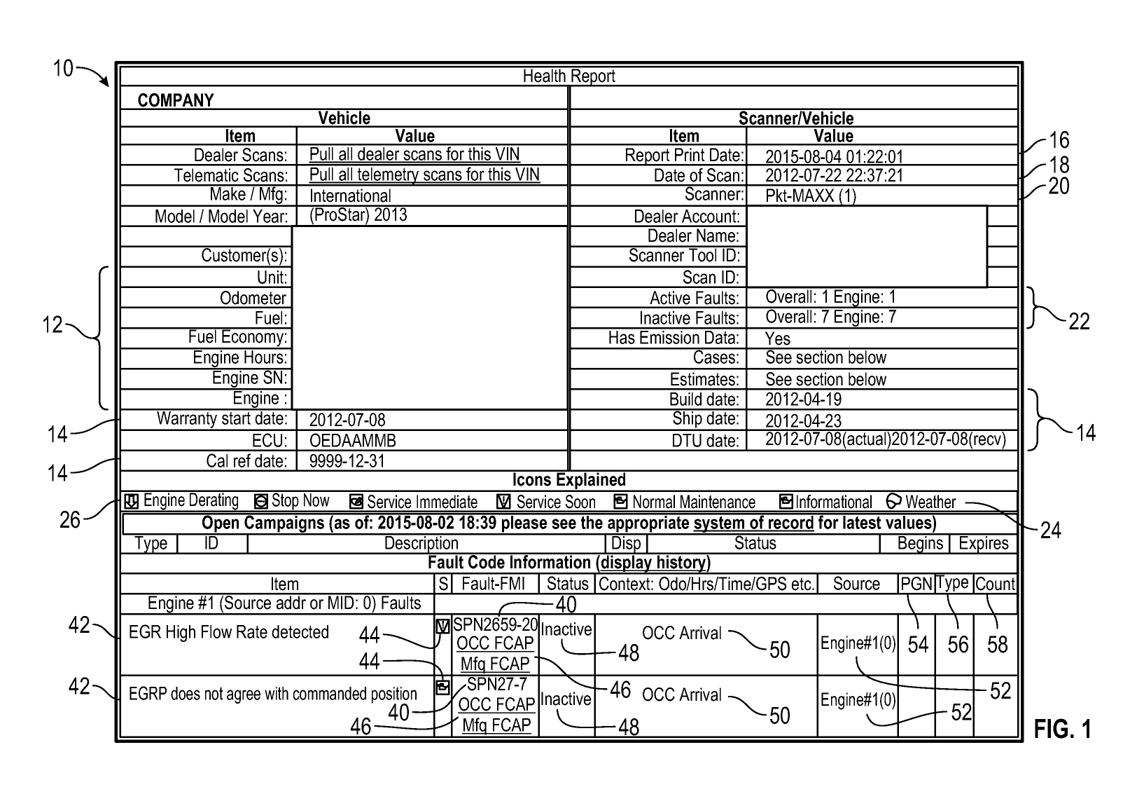

Referring now to FIG. 1, a Vehicle Health Report 10 is shown not utilizing Synthetic Fault Codes or Synthetic Fault Code Action Plans. The Vehicle Health Report 10 includes information such as vehicle and engine characteristics 12, reference dates 14, the report date 16, the scan date 18, the electronic service tool 20 used to scan the vehicle, fault counts 22, and weather information 24. Two or more fault codes 40 are displayed, along with fault code descriptions 42. Fault code severity symbols 44 are displayed along with the fault codes 40, which fault code severity symbols 44 are defined by a severity symbol legend 26. The fault code severity symbols 44 of each fault code 40 are different, giving no indication that the fault codes 40 are related. Each fault code 40 is associated with different a fault code action plan internet link 46, independently and without regard for the other fault codes 40 that are reported in the Vehicle Health Report 10. Thus, the fault code action plan internet link 46 may lead to information that is redundant, overlapping, or contradictory. Other information that may be included with each fault code 40 is the fault code status 48, the fault code context 50, the fault code source 52, the fault code parameter group number 54, the fault code type 56, and the individual fault code count 58.

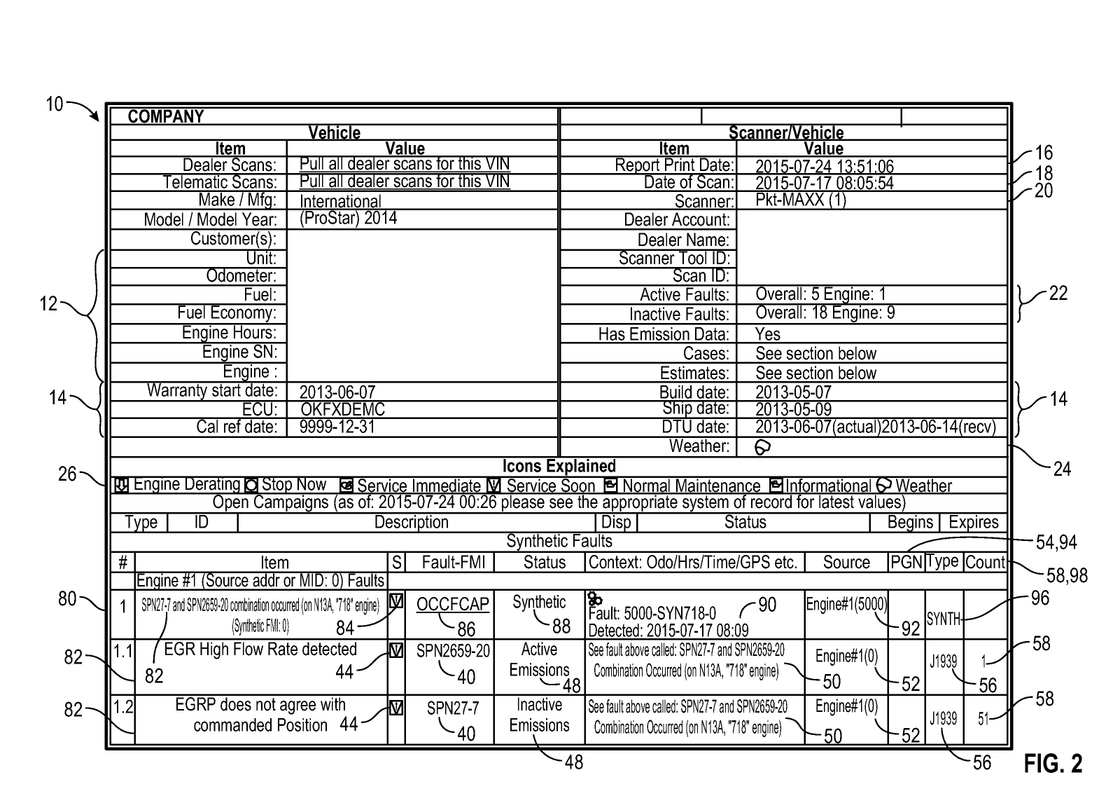

Turning now to FIG. 2, another Vehicle Health Report 10 is shown, this time utilizing an embodiment of the Synthetic Fault Codes 80. The Vehicle Health Report 10 again includes information such as vehicle and engine characteristics 12, reference dates 14, the report date 16, the scan date 18, the electronic service tool 20 used to scan the vehicle, fault counts 22, and weather information 24. Two or more fault codes 40 are again displayed, along with fault code descriptions 42. Fault code severity symbols 44 are again displayed along with the fault codes 40, which fault code severity symbols 44 are again defined by a severity symbol legend 26. As before, other information that may be included with each fault code 40 is the fault code status 48, the fault code context 50, the fault code source 52, the fault code parameter group number 54, the fault code type 56, and the individual fault code count 58. However, no fault code action plan internet link 46 is provided with the fault codes 40, and the fault codes 40, the fault code descriptions 42, the fault code statuses 48, the fault code contexts 50, and the fault code sources 52 are “grayed out,” indicating that no selection may be made of these items.

A Synthetic Fault Code 80 is displayed above the two or more fault codes 40, along with a Synthetic Fault Code description 82, a Synthetic Fault Code severity symbol 84, and a Synthetic Fault Code Action Plan internet link 86. The Synthetic Fault Code Action Plan internet link 86 leads to a Synthetic Fault Code Action Plan (not shown), which is designed to address the entirety of the specific failure or maintenance issue that has triggered the two or more fault codes 40. As with the fault codes 40, other information that may be included with each Synthetic Fault Code 80 is the Synthetic Fault Code status 88, the Synthetic Fault Code context 90, the Synthetic Fault Code source 92, the Synthetic Fault Code parameter group number 94, the Synthetic Fault Code type 96, and the individual Synthetic Fault Code count 98. In this way, the Synthetic Fault Code Action Plan that is obtained by clicking on the Synthetic Fault Code Action Plan internet link 86 addresses interrelated component failures and/or fault codes generated by more than one control module, and minimizes redundant or unnecessary diagnostic paths and repairs.

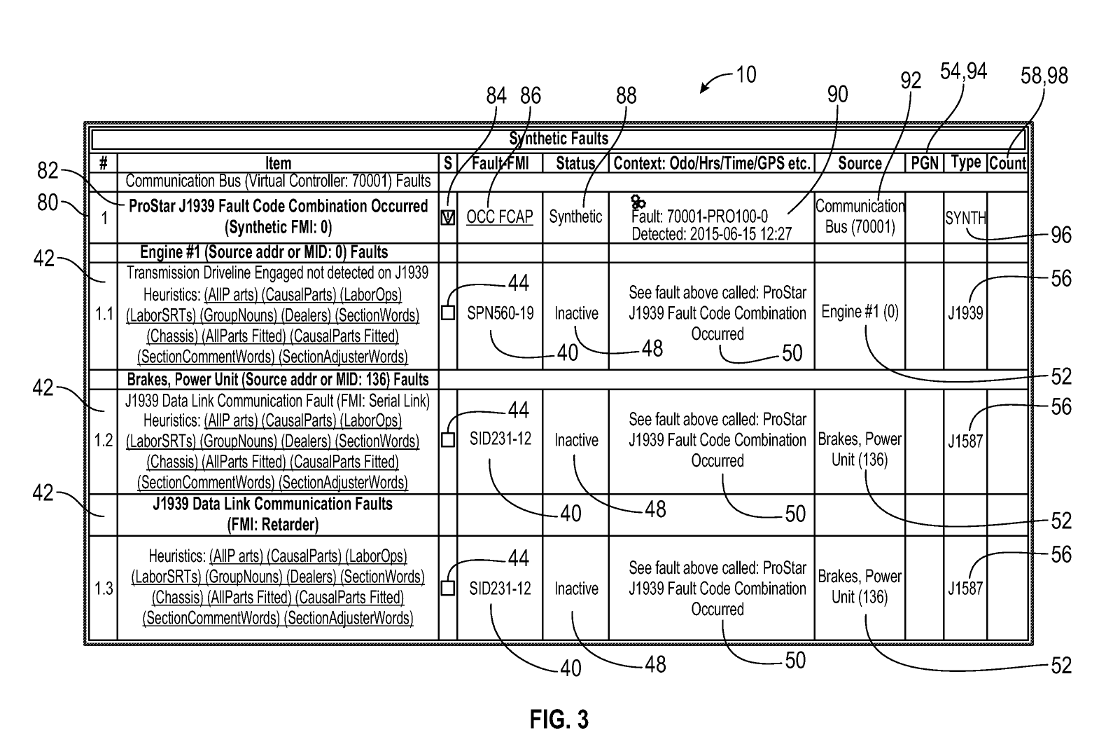

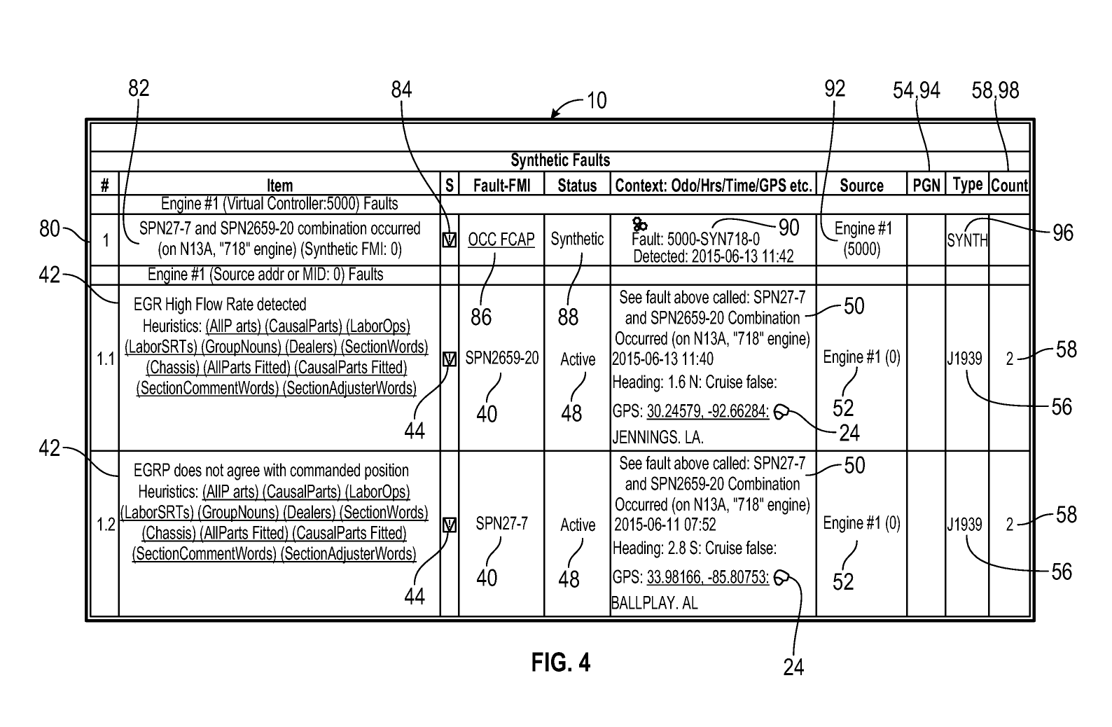

FIGS. 3 and 4 show additional examples of portions of Vehicle Health Reports 10 utilizing fault codes 40 and embodiments of Synthetic Fault Codes 80. The upper parts of the Vehicle Health Reports 10 containing the information such as vehicle and engine characteristics 12, reference dates 14, the report date 16, the scan date 18, the electronic service tool 20 used to scan the vehicle, the fault counts 22, and the severity symbol legends 26 have been omitted in order to focus on the lower parts of the Vehicle Health Reports 10. As before, two or more fault codes 40 are displayed, along with fault code descriptions 42, fault code severity symbols 44, fault code statuses 48, the fault code contexts 50, fault code sources 52, fault code parameter group numbers 54, fault code types 56, and individual fault code counts 58. Additionally, individual weather information 24 may be provided for each fault code 40.

In the case of the Vehicle Health Report 10 of FIG. 3, the individual fault codes 40 are SAE J1939 based fault codes, as shown by the fault code descriptions 42. In the case of the Vehicle Health Report 10 of FIG. 4, the individual fault codes 40 are Exhaust Gas Recirculation system fault codes, also shown by the fault code descriptions 42. No fault code action plan internet link 46 is provided with the fault codes 40 in FIGS. 3 and 4, and the fault codes 40, the fault code descriptions 42, the fault code statuses 48, the fault code contexts 50, and the fault code sources 52 are “grayed out,” indicating that no selection may be made of these items.

Again, a Synthetic Fault Code 80 is displayed above the two or more fault codes 40 in each of FIGS. 3 and 4, along with Synthetic Fault Code descriptions 82, Synthetic Fault Code severity symbols 84, Synthetic Fault Code Action Plan internet links 86, Synthetic Fault Code statuses 88, Synthetic Fault Code contexts 90, Synthetic Fault Code sources 92, Synthetic Fault Code parameter group numbers 94, Synthetic Fault Code types 96, and individual Synthetic Fault Code counts 98. Note that the Synthetic Fault Code severity symbols 84 may be the same as or different from the fault code severity symbols 44. This may be accomplished by setting the Synthetic Fault Code severity symbols 84 to match the most severe of the listed fault code severity symbols 44. Alternately, the setting of the Synthetic Fault Code severity symbols 84 may be based on a level of severity specifically assigned to the Synthetic Fault Code 80, by algorithm or otherwise. The Synthetic Fault Code Action Plan internet links 86 again lead to Synthetic Fault Code Action Plans (not shown), which are designed to address the entirety of the specific J1939 or Exhaust Gas Recirculation failures or maintenance issues that have triggered the two or more fault codes 40. In this way, the Synthetic Fault Code Action Plans that are obtained by clicking on the Synthetic Fault Code Action Plan internet links 86 address interrelated component failures and/or fault codes generated by more than one control module, and minimize redundant or unnecessary diagnostic paths and repairs.

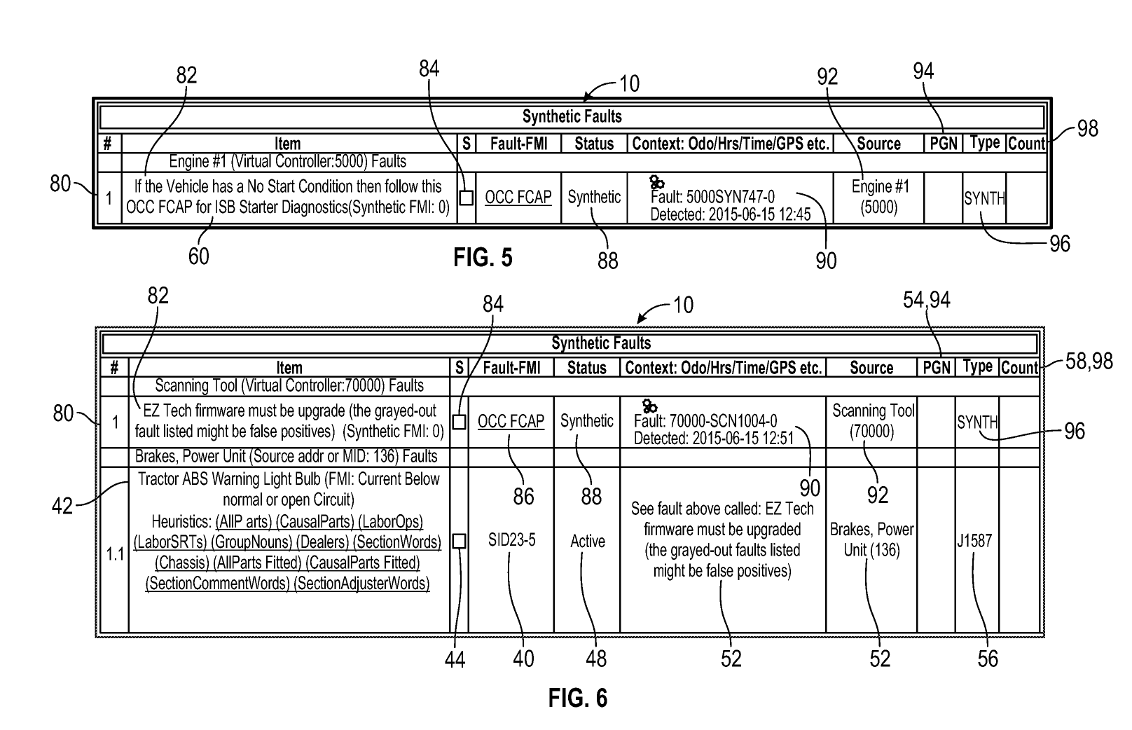

Turning now to FIG. 5, a portion of a Vehicle Health Report 10 is shown with an embodiment of a Synthetic Fault Code 80 having a Synthetic Fault Code Action Plan internet link 86, based at least in part on a customer reported symptom 60. Again, the Synthetic Fault Code 80 is provided with a Synthetic Fault Code description 82, a Synthetic Fault Code severity symbol 84, a Synthetic Fault Code status 88, a Synthetic Fault Code context 90, a Synthetic Fault Code source 92, a Synthetic Fault Code parameter group number 94, a Synthetic Fault Code type 96, and an individual Synthetic Fault Code count 98. Note that the Synthetic Fault Code description 82 presents the technician with a choice of whether to follow the Synthetic Fault Code Action Plan internet link 86, depending upon whether the vehicle has a no start condition.

Similarly, FIG. 6 shows a portion of a Vehicle Health Report 10 with an embodiment of a Synthetic Fault Code 80 having a Synthetic Fault Code Action Plan internet link 86, based in part on an Antilock Braking System fault code 40, as shown by the fault code description 42, and in part on the need to update a service tool software. No fault code action plan internet link 46 is provided with the fault code 40 in FIG. 5, and the fault code 40, the fault code description 42, the fault code severity symbol 44, the fault code status 48, the fault code context 50, and the fault code source 52 are “grayed out,” indicating that no selection may be made of these items. This “grayed out” presentation of the fault code 40 will remain until the service tool software is updated. Again, the fault code 40 is provided with a fault code parameter group number 54, a fault code type 56, and an individual fault code count 58. The Synthetic Fault Code 80 is provided with a Synthetic Fault Code description 82, in this embodiment indicating the need to update the service tool software. The Synthetic Fault Code is again provided with a Synthetic Fault Code severity symbol 84, a Synthetic Fault Code status 88, a Synthetic Fault Code context 90, a Synthetic Fault Code source 92, a Synthetic Fault Code parameter group number 94, a Synthetic Fault Code type 96, and an individual Synthetic Fault Code count 98.

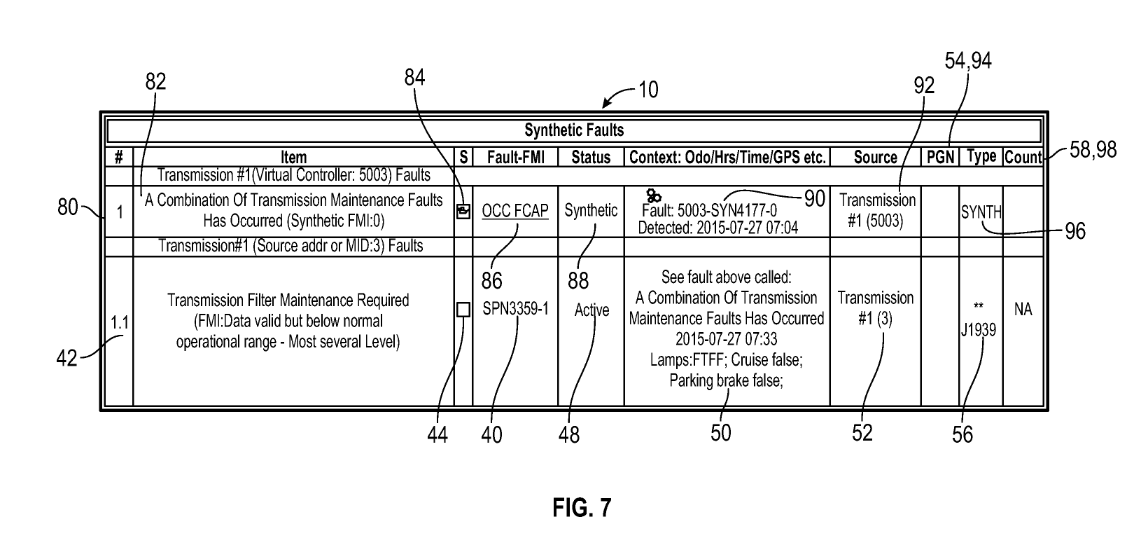

FIG. 7 shows an additional example of a portion of a Vehicle Health Report 10 with an embodiment of a Synthetic Fault Code 80 having a Synthetic Fault Code Action Plan internet link 86, based in part on one or more transmission fault codes 40, as shown by the fault code description 42. In particular, the transmission fault code 40 in FIG. 7 indicates the need for filter maintenance, indicating that the Synthetic Fault Code 80 and Synthetic Fault Code Action Plan internet link 86 may be based on maintenance items, in addition to being based on failures. Again, no fault code action plan internet link 46 is provided with the fault code 40 in FIG. 7, and the fault code 40, the fault code description 42, the fault code severity symbol 44, the fault code status 48, the fault code context 50, and the fault code source 52 are “grayed out,” indicating that no selection may be made of these items. Again, the fault code 40 is provided with a fault code parameter group number 54, a fault code type 56, and an individual fault code count 58. Once again, the Synthetic Fault Code 80 is displayed above the at least one transmission fault code 40, along with a Synthetic Fault Code description 82, a Synthetic Fault Code severity symbol 84, the Synthetic Fault Code Action Plan internet link 86, the Synthetic Fault Code status 88, the Synthetic Fault Code context 90, the Synthetic Fault Code source 92, the Synthetic Fault Code parameter group number 94, the Synthetic Fault Code type 96, and the individual Synthetic Fault Code count 98.

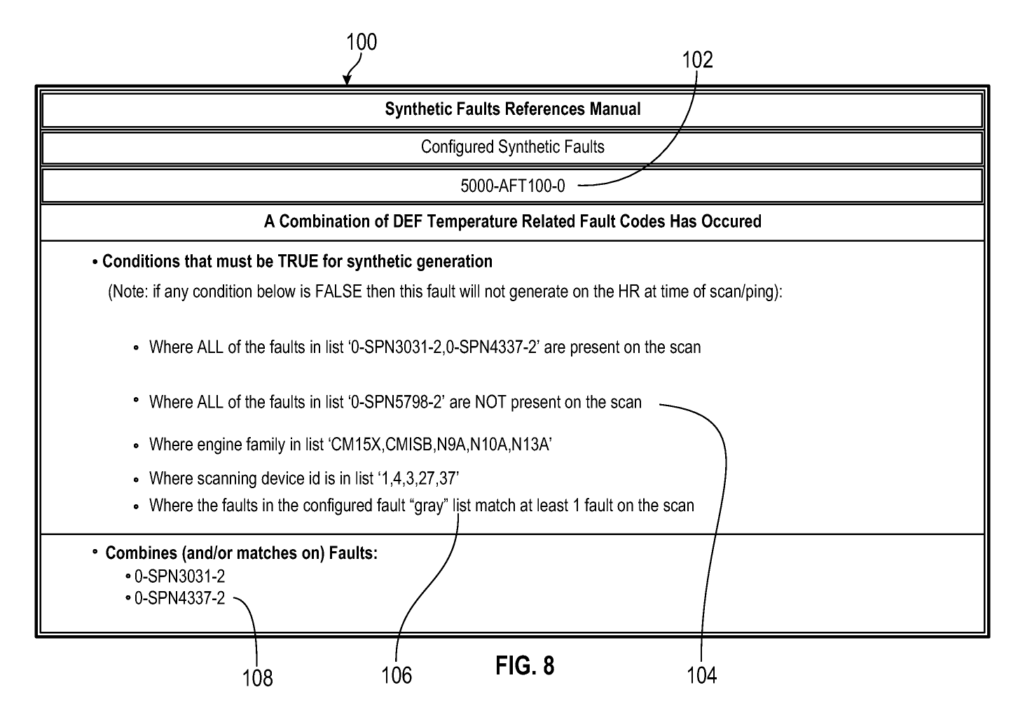

Turning now to FIG. 8, an embodiment of a Synthetic Fault Code administrative tool 100 is shown. The Synthetic Fault Code administrative tool 100 allows for the creation of a Synthetic Fault Code 102, either automatically utilizing an algorithm or manually. Further, the Synthetic Fault Code administrative tool 100 provides for the oversight, validation, and/or editing of the Synthetic Fault Code 102, in either the automatic or manual embodiments of the Synthetic Fault Code administrative tool 100. Synthetic Fault Code configuration logic 104 contains Synthetic Fault Code rules and conditions 106 which must all be true for the generation of a Synthetic Fault Code 102 based on combined fault codes 108.

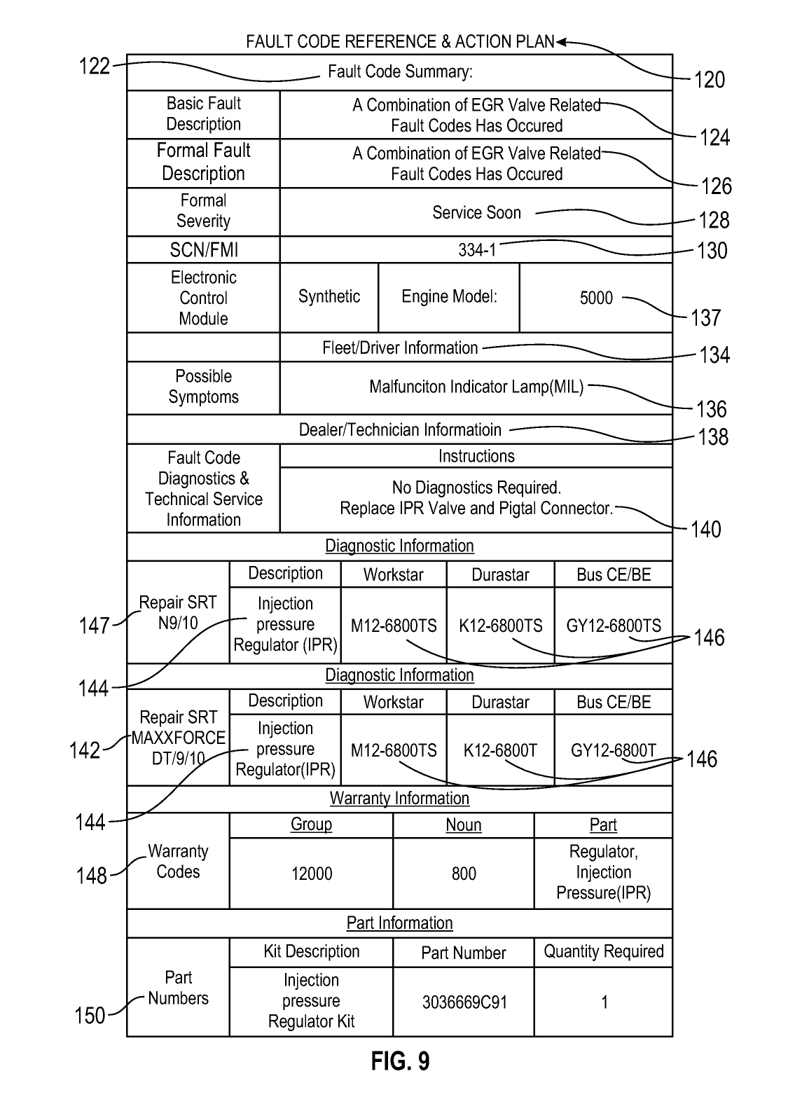

FIG. 9 shows an embodiment of a Synthetic Fault Code Action Plan 120 which may be accessed by clicking on any of the Synthetic Fault Code Action Plan internet links 86 of FIGS. 2 through 7. A Synthetic Fault Code summary field 122 contains a Synthetic Fault Code basic description 124, a Synthetic Fault Code formal description 126, and a Synthetic Fault Code severity message 128 appearing above a Synthetic Fault Code Failure Mode Indicator 130. The Synthetic Fault Code summary field 122 also contains the engine model 132. Beneath the Synthetic Fault Code summary field 122 is a Synthetic Fault Code fleet/driver information field 134, which contains in the present embodiment a customer reported symptom 136. Beneath the Synthetic Fault Code fleet/driver information field 134 is a Synthetic Fault Code dealer/technician information field 138, which contains Synthetic Fault Code instructions 140, as well as diagnostic information including Synthetic Fault Code combined fault codes 142, Synthetic Fault Code combined fault code descriptions 144, and Synthetic Fault Code combined fault code applicable models 146. The Synthetic Fault Code dealer/technician information field 138 may also contain warranty information 148 and part number information.

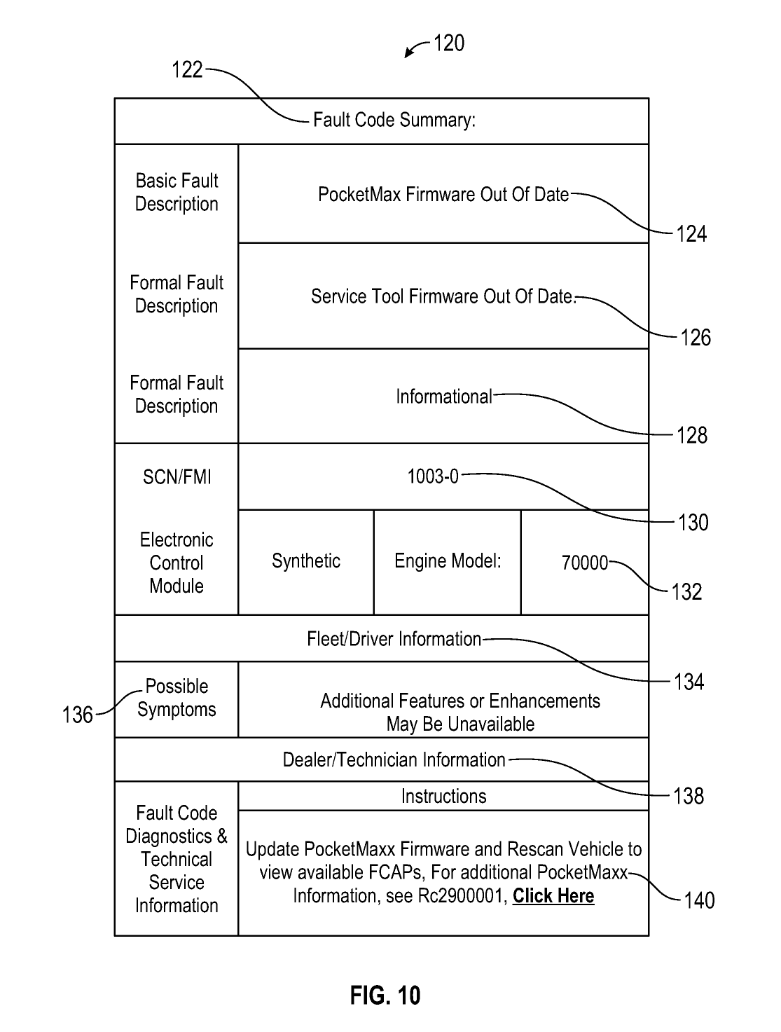

FIG. 10 shows a partial view of another embodiment of a Synthetic Fault Code Action Plan 120 which may be accessed for example by clicking on the Synthetic Fault Code Action Plan internet link 86 of FIG. 5. A Synthetic Fault Code summary field 122 again contains a Synthetic Fault Code basic description 124, a Synthetic Fault Code formal description 126, and a Synthetic Fault Code severity message 128, a Synthetic Fault Code Failure Mode Indicator 130, and the engine model 132. Beneath the Synthetic Fault Code summary field 122 is the Synthetic Fault Code fleet/driver information field 134, which contains a field for any customer reported symptom 136. Beneath the Synthetic Fault Code fleet/driver information field 134 is a Synthetic Fault Code dealer/technician information field 138, which contains Synthetic Fault Code instructions 140 indicating the need to update a service tool software.

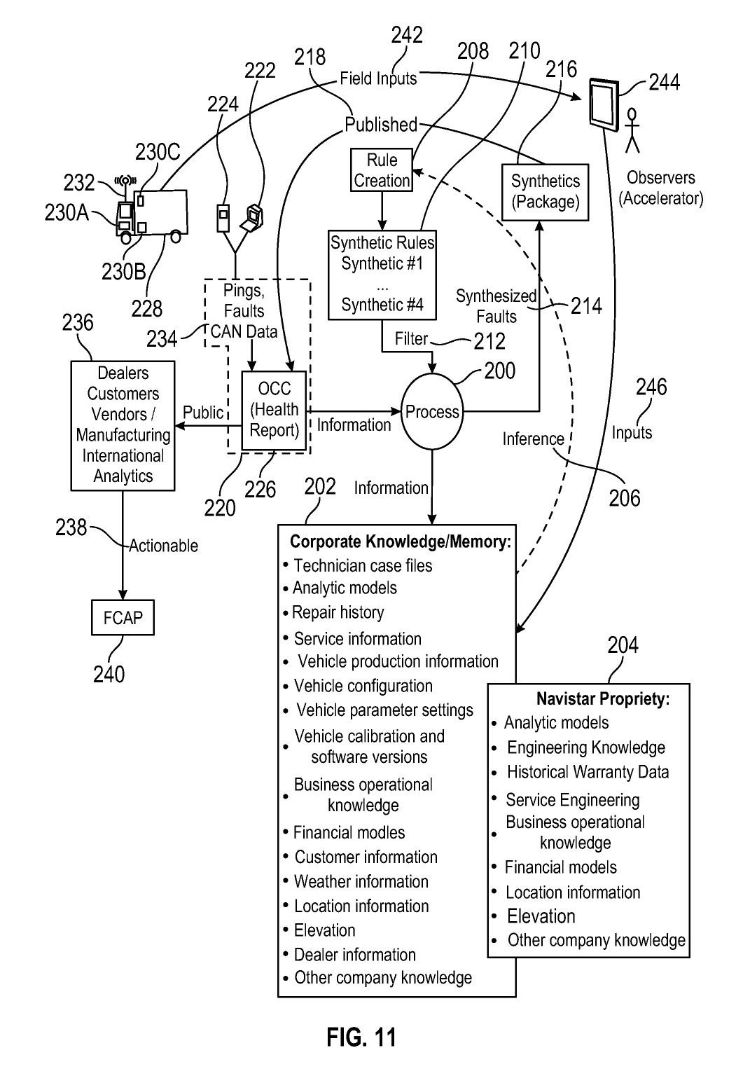

Turning now to FIG. 11, a graphical representation is shown of an embodiment of a system and method for correlating information regarding current vehicle conditions, current fault codes of various controllers, current environmental conditions, current GPS reported location, and/or current customer reported symptoms using Synthetic Fault Codes 214. At the heart of the embodiment of the system and method shown is at least one synthetics rules creation processor or portal 208 that generates synthetics rules 210 for use by at least one synthetic fault processor or synthetics engine 200. The at least one synthetics rules creation processor or portal 208 functions to recognize previously unrecognized correlations between previous vehicle conditions, previous fault codes of various vehicle electronic control modules 230, previous environmental conditions, previous GPS reported location, and/or previous customer reported symptoms using inferences 206 derived at least in part from corporate knowledge and/or memory 202, and/or company proprietary information 204. The at least one synthetics rules creation processor or portal 208 may function to recognize previously unrecognized correlations utilizing at least one correlation recognizing algorithm. The at least one synthetics rules creation processor or portal 208 then generates the synthetics rules 210 based on these correlations. The at least one synthetics rules creation processor or portal 208 may function entirely autonomously using the at least one correlation recognizing algorithm, or may require validation, oversight, or direct guidance, such as by a technician, programmer, or engineer pre-identifying vehicle conditions and/or creating Synthetic Fault Code Action Plans 240, using an administrative tool (not shown).

The synthetics rules 210 are then used by the at least one synthetic fault processor or synthetics engine 200 in triggering one or more Synthetic Fault Codes 214. Each specific synthetic rule 210, although created for use in triggering a given Synthetic Fault Code 214, may be used for multiple related Synthetic Fault Codes 214. The synthetics rules 210, Synthetic Fault Codes 214, and previous Vehicle Health Reports 226 may be stored in the corporate knowledge and/or memory database or facility 202, or in a separate diagnostic database or system, together with or separate from the usual individual fault codes of the various vehicle electronic control modules 230, for use by the at least one synthetic fault processor or synthetics engine 200. The synthetics rules 210 may pass through a filter 212 between the at least one synthetics rules creation processor or portal 208 before being used by the at least one synthetic fault processor or synthetics engine 200, which filter 212 may identify and/or remove conflicting, redundant, or otherwise flawed synthetics rules 210.

Logic circuits or programming within the at least one synthetic fault processor or synthetics engine 200 evaluate current vehicle data, current vehicle conditions, current fault codes 234 of the vehicle 228, and/or current customer reported symptoms, all of which may be provided by way of a Vehicle Health Report 226 through a connectivity system 220. The vehicle data and conditions may include in addition to fault codes, the date, mileage, engine hours operated, number of shifts, brake applications, and etcetera, location, routes travelled, where, when, and how often the fault(s) occurred, as non-limiting examples. The current vehicle data, current vehicle conditions, current fault codes 234 of the vehicle 228, and/or current customer reported symptoms are evaluated by the at least one synthetic fault processor or synthetics engine 200 against the synthetics rules 210 generated by the at least one synthetics rules creation processor or portal 208, in order to determine whether to trigger the Synthetic Fault Codes 214. The Synthetic Fault Codes 214 are then published 218 as part of a synthetics package 216, which then becomes part of the Vehicle Health Report 226. In this way, the current vehicle data, current vehicle conditions, current fault codes 234 of the vehicle 228, and/or current customer reported symptoms are being evaluated against past and present Vehicle Health Reports 226 in a recursive process including inferences drawn from previous vehicle data, previous vehicle conditions, previous fault codes 234 of vehicles 228, previous customer reported symptoms corporate knowledge and/or memory 202, and/or company proprietary information 204.

Customer reported symptoms may be reported to the connectivity system 220 by way of a service portal 222 or electronic service tool 224, or may be reported telematically 232, whereupon the customer reported symptoms may be assigned numbers or even their own fault codes. The data, conditions, and fault codes 234 of the vehicle 228 may include information from the vehicle CAN bus originating from any of several vehicle electronic control modules 230, including but not limited to an engine control module 230A, a transmission control module 230B, and/or a body control module 230C. This information may be obtained from the vehicle 228 directly, by way of the service portal 222 or electronic service tool 224, or by way of telematics 232.

The Vehicle Health Report 226, once created, is provided to the public 236, including to dealers, customers, vendors, and manufacturing, along with actionable intelligence 238 in the form of a Synthetic Fault Code Action Plan 240. The at least one Synthetic Fault Code Action Plan 240 functions to communicate specific repair or maintenance information to a dealer or fleet technician specific to the combination of vehicle data, conditions, and fault codes 234, corporate knowledge and/or memory 202, company proprietary information 204, and/or customer reported symptoms that are identified. If applicable, the at least one synthetic fault processor or synthetics engine 200 may automatically “push” the repair or reprogramming as set forth in the at least one Synthetic Fault Code Action Plan 240.

Meanwhile, field inputs 242 are provided by the vehicle 228, possibly by way of telematics 232, to an accelerator tool 244. These items of information and/or customer reported symptoms may be identical to, similar to, or distinct from the information and/or symptoms provided to the at least one synthetic fault processor or synthetics engine 200 by way of previous Vehicle Health Reports 226 as part of the aforementioned recursive process. Furthermore, the field inputs 242 may include data and information from not only one, but a fleet, or even the entire population of a given vehicle type. The accelerator tool 244, which may for example be a handheld data entry tool, or an accelerator portal, allows entry of human observations associated with fault codes that are reported, which together become part of the corporate knowledge and/or memory 202 by way of corporate knowledge and/or memory input 246. These human observations may themselves be assigned fault codes, similar to the customer reported symptoms. These combined human observations and fault codes and/or customer reported symptoms then become part of the corporate knowledge and/or memory 202, and/or part of the Vehicle Health Report 226. In at least one embodiment, the Synthetic Fault Code Action Plans 240 are created using the accelerator tool 244, and become available to the at least one synthetic fault processor or synthetics engine 200 by way of the corporate knowledge and/or memory 202. This is therefore another recursive part of the embodiment of the system and method shown in FIG. 11 for correlating information regarding vehicle conditions, fault codes of various controllers, environmental conditions, GPS reported location, and/or customer reported symptoms.

While the system and method for correlating information regarding vehicle conditions, fault codes of various vehicle subsystem controllers, environmental conditions, GPS reported location, and/or customer reported symptoms, using Synthetic Fault Codes, and for providing at least one Synthetic Fault Code Action Plan has been described with respect to at least one embodiment, the system and method can be further modified within the spirit and scope of this disclosure. This application is therefore intended to cover any variations, uses, or adaptations of the system and method using its general principles. Further, this application is intended to cover such departures from the present disclosure as come within known or customary practice in the art to which the disclosure pertains and which fall within the limits of the appended claims.

What is claimed is:

1. A system for correlating vehicle related information, comprising:
at least one synthetics rules creation processor or portal configured to recognize at least one correlation between:
one previous vehicle datum, previous vehicle condition, corporate knowledge, corporate memory, company proprietary information, previous GPS reported location, previous customer reported symptom, or previous fault code generated by at least one vehicle electronic control module,
and another previous vehicle datum, previous vehicle condition, corporate knowledge, corporate memory, company proprietary information, previous GPS reported location, previous customer reported symptom, or previous fault code generated by at least one vehicle electronic control module;
the at least one synthetics rule creation processor or portal further configured to generate at least one synthetic rule based on the at least one correlation;
at least one synthetic fault processor or synthetics engine configured to compare against the at least one synthetic rule at least one of:
a current vehicle datum, a current vehicle condition, a current GPS reported location, a current customer reported symptom, and a current fault code generated by at least one vehicle electronic control module; and
the at least one fault processor or synthetics engine being further configured to generate at least one synthetic fault code based upon a matching comparison, the at least one synthetic fault code thereafter becoming part of a vehicle health report.

2. The system for correlating vehicle related information of claim 1, wherein:
the at least one rules creation processor or portal autonomously recognizing the at least one correlation using at least one correlation recognizing algorithm.

3. The system for correlating vehicle related information of claim 1, wherein:
the at least one fault processor or synthetics engine being further configured to generate at least one synthetic fault code action plan, the at least one synthetic fault code action plan being published along with the at least one synthetic fault code as part of a synthetics package, the at least one synthetic fault code and the at least one synthetic fault code action plan thereafter becoming part of the vehicle health report.

4. The system for correlating vehicle related information of claim 3, wherein:
the at least one fault processor or synthetics engine being further configured to gray-out in the vehicle health report any previous fault code and fault code action plan upon the correlation of which fault code the at least one synthetic rule is based.

5. The system for correlating vehicle related information of claim 3, wherein:
the at least one synthetic fault processor or synthetics engine being further configured to compare against the at least one synthetic rule at least one previous vehicle health report.

6. The system for correlating vehicle related information of claim 1, further comprising:
an accelerator tool being configured to receive at least one of field inputs from at least one vehicle electronic control module and customer reported symptoms;
the accelerator tool being further configured to allow entry of human observations and to associate the human observations with at least one of the field inputs and customer reported symptoms; and
the accelerator tool being further configured to make the human observations associated with at least one of the field inputs and customer reported symptoms part of at least one of the corporate knowledge or memory and the vehicle health report.

7. The system for correlating vehicle related information of claim 1, further comprising:
a filter between the at least one synthetics rules creation processor or portal and the at least one synthetic fault processor or synthetics engine filter for at least one of identifying and removing conflicting, redundant, or otherwise flawed synthetics rules.

8. The system for correlating vehicle related information of claim 1, wherein:
at least one of:
the at least one synthetics rules creation processor or portal being further configured to prioritize at least one correlation over another correlation in generating the at least one synthetic rule,
the at least one synthetics rules creation processor or portal being further configured to generate the at least one synthetic rule having at least one Boolean operation,
the at least one synthetics rules creation processor or portal being further configured to generate the at least one synthetic rule having at least one threshold value,
the at least one synthetics rules creation processor or portal being further configured to assign each customer reported symptom a fault code,
the at least one synthetics rules creation processor or portal being further configured to assign each human observation a fault code,
the synthetics rules creation processor or portal being further configured to generate the at least one synthetic rule based on the recognition of out of date service tool software, and
the synthetics rules creation processor or portal being further configured to generate the at least one synthetic rule based on a recall or repair campaign.

9. A method for correlating vehicle related information, comprising the steps of:
recognizing with at least one synthetics rules creation processor or portal at least one correlation between:
one previous vehicle datum, previous vehicle condition, corporate knowledge, corporate memory, company proprietary information, previous GPS reported location, previous customer reported symptom, or previous fault code generated by at least one vehicle electronic control module,
and another previous vehicle datum, previous vehicle condition, corporate knowledge, corporate memory, company proprietary information, previous GPS reported location, previous customer reported symptom, or previous fault code generated by at least one vehicle electronic control module;
generating with the at least one synthetics rules creation processor or portal at least one synthetic rule based on the at least one correlation;
comparing at least one of:
a current vehicle datum, a current vehicle condition, a current GPS reported location, a current customer reported symptom, and a current fault code generated by at least one vehicle electronic control module
against the at least one synthetic rule using at least one synthetic fault processor or synthetics engine;
generating at least one synthetic fault code based upon a matching comparison using the at least one fault processor or synthetics engine; and
making the least one synthetic fault code part of a vehicle health report.

10. The method for correlating vehicle related information of claim 9, further comprising the steps of:
autonomously recognizing with the at least one rules creation processor or portal the at least one correlation using at least one correlation recognizing algorithm.

11. The method for correlating vehicle related information of claim 9, further comprising the steps of:
generating at least one synthetic fault code action plan using the at least one fault processor or synthetics engine;
publishing the at least one synthetic fault code action plan along with the at least one synthetic fault code as part of a synthetics package; and
making the at least one synthetic fault code and the at least one synthetic fault code action plan part of the vehicle health report.

12. The method for correlating vehicle related information of claim 11, further comprising the steps of:
graying-out in the vehicle health report using the at least one fault processor or synthetics engine any previous fault code and fault code action plan upon the correlation of which fault code the at least one synthetic rule is based.

13. The method for correlating vehicle related information of claim 11, further comprising the steps of:
comparing using the at least one synthetic fault processor or synthetics engine at least one previous vehicle health report against the at least one synthetic rule.

14. The method for correlating vehicle related information of claim 9, further comprising the steps of:
receiving with an accelerator tool at least one of field inputs from at least one vehicle electronic control module and customer reported symptoms;
entering human observations and associating the human observations with at least one of the field inputs and customer reported symptoms using the accelerator tool; and
making the human observations associated with at least one of the field inputs and customer reported symptoms part of at least one of the corporate knowledge or memory and the vehicle health report.

15. The method for correlating vehicle related information of claim 9, wherein:
at least one of:
the at least one synthetics rules creation processor or portal further prioritizing at least one correlation over another correlation in generating the at least one synthetic rule,
the at least one synthetics rules creation processor or portal further generating the at least one synthetic rule having at least one Boolean operation,
the at least one synthetics rules creation processor or portal further generating the at least one synthetic rule having at least one threshold value,
the at least one synthetics rules creation processor or portal further assigning each customer reported symptom a fault code,
the at least one synthetics rules creation processor or portal further assigning each human observation a fault codes,
the synthetics rules creation processor or portal further generating the at least one synthetic rule based on the recognition of out of date service tool software, and
the synthetics rules creation processor or portal further generating the at least one synthetic rule based on a recall or repair campaign.
